(19) United States
(12) Patent Application Publication
(10) Pub. No.: US 2009/0302717 A1
(43) Pub. Date: Dec. 10, 2009

(54) Brushless motor apparatus and method

(76) Inventor: Leslie Hoffman, Tarzana, CA (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/455,461

(22) Filed: Jun. 2, 2009

Related U.S. Application Data
(60) Provisional application No. 61/130,912, filed on Jun. 4, 2008.

(51) Int. Cl. H02K 9/02

(52) U.S. Cl. 310/60 A

(57) ABSTRACT

The present invention is a brushless electric motor that can be used in high performance applications, such as model airplanes. The rotor assembly, which includes the rotor shaft, encloses a winding core, which is part of a fixed stator assembly. Conducting wire in the armature portion of the stator assembly is wrapped around a set of spokes, extending radially from an inner hub. The spokes are formed from a stack of flat metal laminations, the laminations oriented perpendicular to the rotation axis. The spokes are wrapped with a single layer of copper wire, which is connected to the energy source when the motor is operational. These spokes are long relative to the diameter of the inner hub, leaving V-shaped slots through the winding core. Openings in both end bells allow air to freely flow into the core, cooling the single layer of conducting wire. Using a wedge to force the wire against the spokes during varnishing results in close contact between the wire and the conducting material in the winding core. When the motor is operational, this contact causes the winding core to act as a heat sink, allowing a relatively heavy motor to sustain high power without damage.

### CROSS-REFERENCES TO RELATED APPLICATIONS

This application claims the benefit of U.S. Provisional Application No. 61/130,912, filed Jun. 4, 2008, having inventor Leslie Hoffman and entitled “Brushless Motor Apparatus,” and hereby incorporated by reference.

### FIELD OF THE INVENTION

The present invention relates to electric motors. More specifically, the invention relates electronically commutated brushless motors.

### BACKGROUND OF THE INVENTION

Brushless DC motors are widely used in hobby applications such as model aviation. The advent of lithium secondary batteries and low “on” resistance power integrated circuits have permitted rapid advances in model aviation. The high power to weight ratios now available with electrically commutated motors powered by lithium batteries have permitted sustained flights of model helicopters and high speed ducted fan powered model jets. Traditional brushless motor designs for model aviation are derived from the CD/DVD-ROM drive industries. Despite recent advances, there is a continuing need for better brushless motors. More power handling ability and lighter weight than can be achieved by the older motor designs are advantageous in the application of modern model aircraft.

### SUMMARY OF THE INVENTION

The motor of the present invention achieves very high performance and exhibits a very wide efficient operating range. The permanent magnet structures are carried on a rotor that overhangs and surrounds the inner stator. The rotor spins outside the stator structures in a configuration commonly called “outrunner”.

The rotor is an insert injection molded piece with features to locate permanent magnets. The stator includes the armature structure and is very compact. The armature laminations form radial spokes, about which relatively thick (low gauge) wire is wound in a single layer. In contrast to conventional practice in which the armature is filled with as much conducting material as possible, radial slots between the spokes allow air to circulate across the wire. The inner hub from which the spokes radiate has a small diameter. Because of the combination of these two aspects, the ratio of open space to solid material in the winding core is low compared to conventional practice.

After the wire is wound around the spokes, a wedge is used to hold the wire tightly against the spokes while the wire is varnished into place. Because of the substantial contact consequently achieved once the varnish cures between the wire and the armature laminations, the armature laminations serve as a sink for heat generated in the wire when the motor is operational.

Several other features also contribute to improving heat transfer away from the wire coils, thereby improving performance. The end bells enclosing the winding core at both ends are open. The rotor end bell has deep blades, effectively pushing the air like a fan as the shaft rotates. The mounting end bell includes skeletal struts that reduce resistance to air flow, both axially and radially. The openings through the winding core and the end bells combine to facilitate axial air flow to cool the conducting material in the single layer of wire.

The rotating components are supported by a very low profile collection of bearings. The overall design structure and construction techniques permit sustained dissipation of heat and remarkable efficiency at all power settings in a lightweight assembly.

### BRIEF DESCRIPTION OF THE DRAWINGS

FIG. 1 depicts a first embodiment of the motor.

FIG. 2 depicts a single lamination of the wiring core viewed in the Z-direction.

FIG. 3 depicts the armature assembly portion of the stator assembly in isolation.

FIG. 4 illustrates an embodiment of a winding wedge.

FIG. 5 depicts the mounting end bell, including struts, in isolation, viewed toward the positive Z-direction.

FIG. 6 shows the rotor assembly in isolation.

FIG. 7 shows the rotor assembly, including rotor struts in isolation, viewed toward the positive Z-direction.

FIG. 8 shows an alternate embodiment of the motor.

### DETAILED DESCRIPTION OF EXEMPLARY EMBODIMENTS

The figures and associated text illustrate exemplary embodiments, which are not intended to be comprehensive of the scope of the invention. A person of ordinary skill in the art will recognize many embodiments of the inventive concept that are not explicitly detailed here.

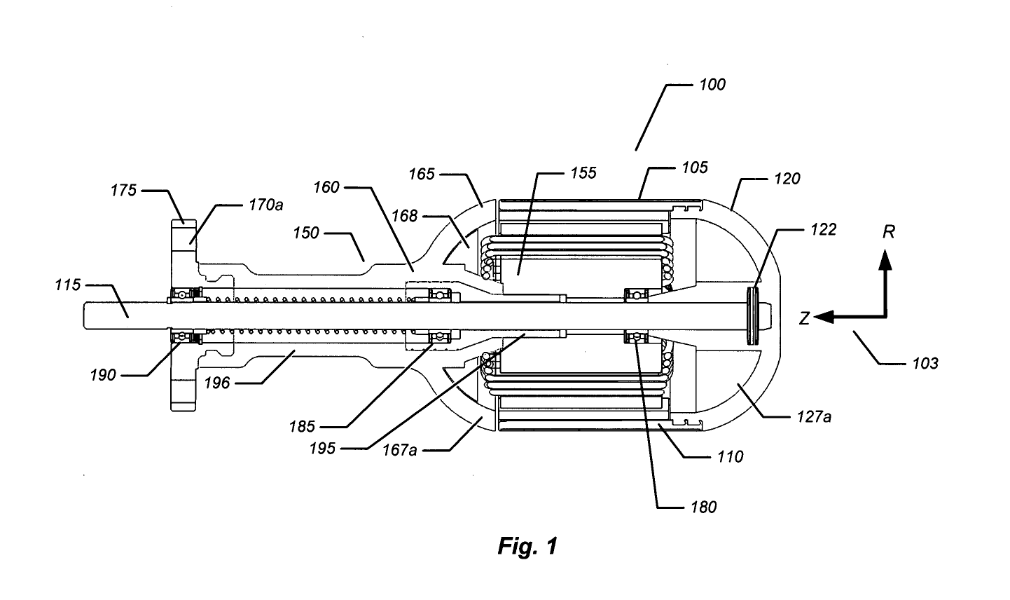

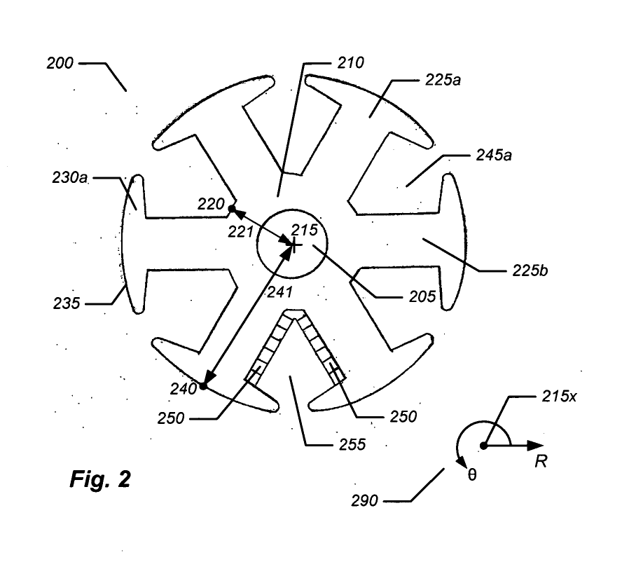

FIG. 1 depicts a first embodiment of the motor 100, shown in cross-section. To orient the figures, a cylindrical coordinate system (R, θ, Z) is used. The cross-section is in a plane parallel to the Z-axis. As shown by the inset 103 in FIG. 1, the Z-axis points along the axis of the shaft 115 of the motor 100, toward the end where the shaft 115 would engage the load when the motor 100 is operational. The R-direction is radially outward from the axis of the shaft 115. θ (see FIG. 2) is an angle about the Z-axis, in a plane perpendicular to the Z-axis.

The motor 100 includes a rotor assembly 105 and a stator assembly 150. The rotor assembly 105 is made up of a rotor cylinder 110 and the power delivery shaft 115, insert-molded into a rotor end bell 120 (also known as a rotor end “cap”). The rotor end bell 120 includes a plurality of blades 127, typified by blade 127a, for structural support. A roll pin 122 through the shaft 115 is encapsulated by the rotor end bell 120, ensuring the coupling of the rotor end bell 120 to the shaft 115 as the shaft 115 rotates. While the rotor end bell 120 is being molded, the mold holds the rotor cylinder 110 and the power delivery shaft 115 in proper axial and radial relationship.

The rotor end bell 120 is fabricated from structural thermoplastic. Any of a number of thermoplastics may be used, but RYTON R-4-200BL, a composite of resin and fiberglass, is one thermoplastic found to have the advantages of high strength and the ability to withstand high temperatures. All the thermoplastic parts in the motor may be fabricated from RYTON R-4-200BL or similar material.

The stator assembly 150 includes the armature assembly 155, which is supported, at least in part, by a bushing support 160. The bushing support 160 is in turn supported by the mounting end bell 165 (also known as a “stator end bell/cap”), which is also a molded structural thermoplastic part. These elements are stationary when the motor is operating. The framework of the mounting end bell 165 includes a plurality of struts 167, typified by 167a, describing openings 168. The stator assembly 150 includes a mounting flange 175, which has mounting holes 170, typified by mounting hole 170a, to mount the motor 100 for use. In the embodiment shown, bearings 180, 185 and 190 facilitate smooth rotation of the shaft 115. Bearing 185 is enclosed by a bushing 195 within the bushing support 160. Other than the bearings and the bushing 195, the remainder of the shaft enclosure 196 may be fabricated from structural thermoplastic.

The armature assembly 155 is formed from a stack 330 of laminations 200, each lamination 200 oriented perpendicular to the Z-axis in an assembled motor 100. A representative lamination 200 is shown in FIG. 2. For reference, coordinate axes 290 are shown, but for clarity, they are offset from their correct position; namely, the point 215×should be regarded as coinciding with the center 215 of the lamination 200. The Z-axis is perpendicular to the paper.

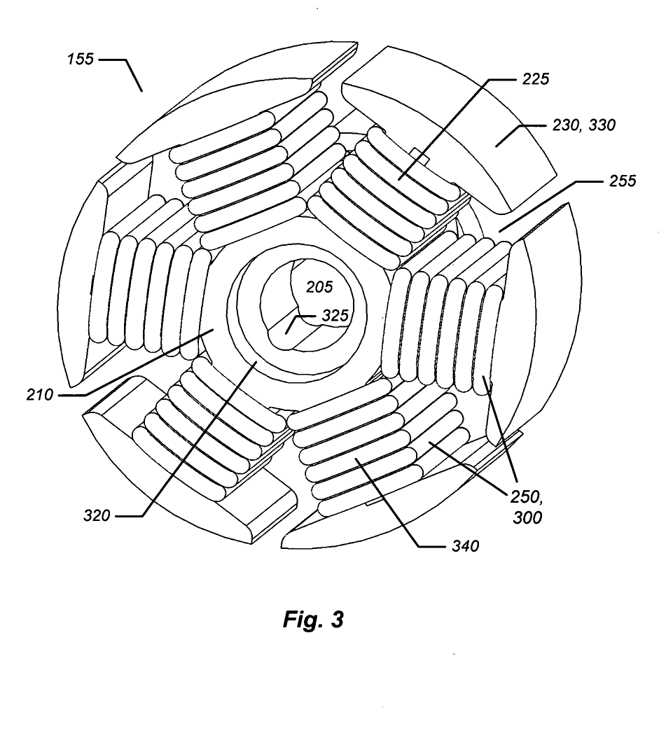

The lamination 200 is stamped from thin, flat, metal, such as steel, that has a high magnetic permeability. The lamination 200 may have small indentations (not shown) in its surface, for alignment with adjacent laminations in the stack 330. At the center of the lamination 200 is a circular shaft hole 205, through which the shaft 115 of the rotor assembly 105 passes. (It should be noted that not all laminations 200 have the same shaft hole 205 size. The radius of the shaft hole 205 may be enlarged in some laminations 200 relative to others, to serve as a counterbore 320 to hold bushing 195 or bearing 180. In some laminations 200, the shaft hole 205 in the lamination 200 may be modified by a key 325, a groove used for alignment. Such a counterbore 320 and a key 325 are shown in FIG. 3.) Immediately surrounding the shaft hole 205 is a ring of material, forming the remainder of the central hub 210. The outer radius RH 221 of the central hub 210 is the distance from the center 215 of the lamination 200 to the point labeled 220. Extending from the central hub 210 are a set of spokes 225, typified by 225a and 225b. The spokes 225 are spaced at equal intervals of angle θ around the central hub 210. For a three-phase motor 100, the number of spokes 225 will be a multiple of three. The armature 155 shown has six spokes 225.

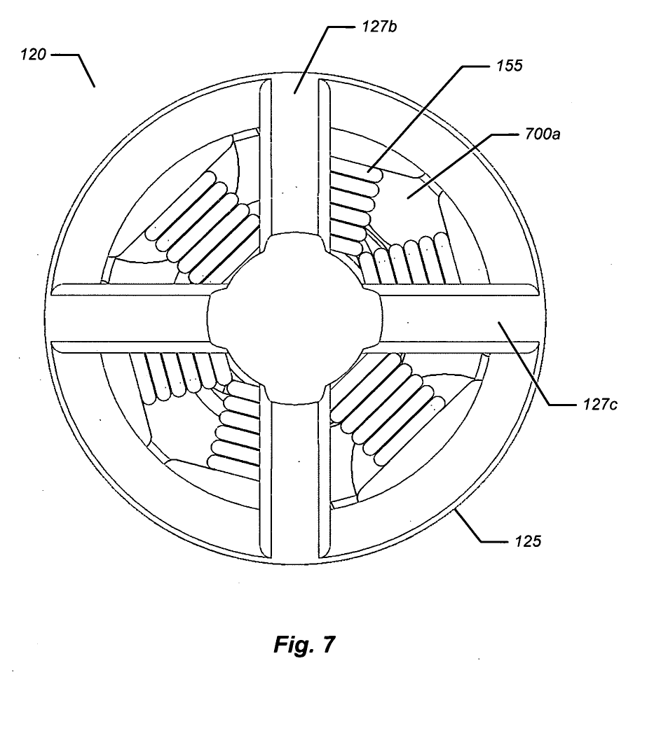

Each spoke 225 terminates in a spoke cap 230, typified by spoke cap 230a. The outermost edges of the spoke caps 230 lie on a circle 235, about which the rotor cylinder 110 rotates (see FIG. 7). The radius RR 241 of this circle 235 is the distance from the center 215 of the lamination 200 to point 240 in FIG. 2. The ratio of RH/RR is preferably less than 50%, which is true for the embodiment shown. The difference RR-RH is the length L of each spoke 225. In the embodiment shown, the ratio of the width W of each spoke 225 to L is less than 60%, and the ratio of the thickness (along a radius) of a spoke cap 230 to L is less than 30%. The combination of these dimensions results in large slots 245 between the spokes 225, typified by slot 245a, with a ratio of area of empty space to solid material outside the central hub 210 greater than 50%. As will be described in relation to FIG. 3, the laminations 200 are wrapped with wire 250 to form the winding core 340. FIG. 2 illustrates the thickness of the single layer of wire wrapping 250 (shown in cross-section) on a pair of selected typical adjacent spokes 225, and the somewhat reduced size of a typical slot 255 after wiring.

FIG. 3 depicts the armature assembly 155 portion of the stator assembly 150 in isolation. The laminations 200 are pressed together into a stack 330, coated, and wrapped with wire 250 to form windings 300. The set of windings 300 form the winding core 340 of the armature assembly 155. When the motor 100 is in operation, electricity passing through the winding core 340 from a power source exerts magnetic forces on magnets 620 contained in the rotor assembly 105, causing the shaft 115 to rotate the load.

The wire 250 that wraps each spoke 225 in the winding core 340 is conducting wire 250, typically copper or copper-based. Because wire heat is proportional to wire resistance, which is, in turn, inversely proportional to area, according to conventional reasoning, the wire should be wrapped with a plurality of layers of thin gauge copper wire. Accordingly, the available core volume in an armature 155 is typically filled with the maximum practical amount of conductor volume, so that no valuable armature core is wasted as air space.

The inventor has found that the conventional approach is prone to thermal runaway. At high power density, as power continues to increase, temperature increases, which causes power to increase, and so forth. Eventually, the winding core will burn up.

Applicant has realized that the conventional approach of using multiple layers of copper wire prevents the inner layers from exposure to cooling air. In contrast, the spokes 225 in the winding core 340 shown in FIG. 3 are very tightly wrapped with a single layer of conducting wire 250 having a relatively thick gauge. The resulting open structure in the armature allows a large amount of air to pass over and cool each conductor.

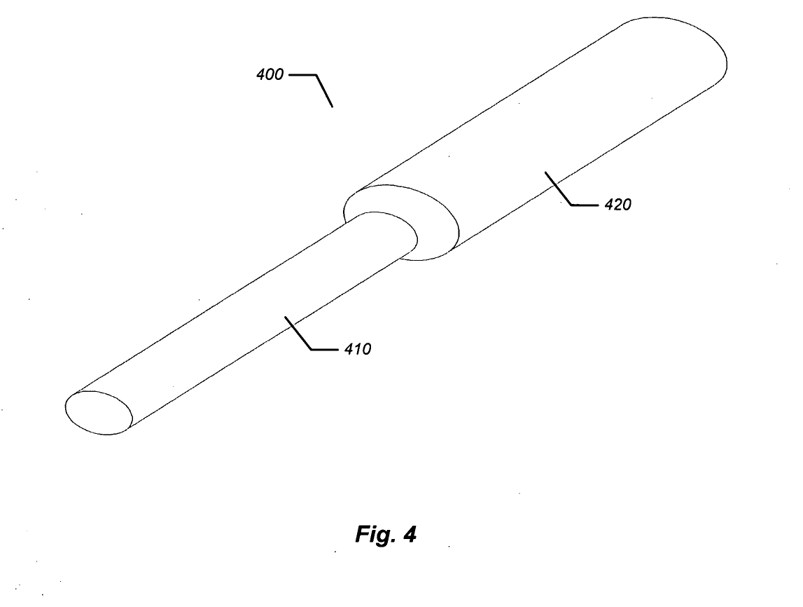

The winding may be performed by a machine that translates as the wire, under tension, is looped around a spoke, so that adjacent wire loops are positioned radially closely adjacent to each other. After winding, a winding wedge 400 is inserted between adjacent spokes to keep the wire 250 flush against the spokes 225. An example of a wedge 400 is shown in FIG. 4, although a practitioner of ordinary skill in the art will realize that many alternative configurations would provide essentially identical functionality. The illustrated wedge 400 is made from a flexible material, such as rubber or silicone rubber. The wedge 400 has a narrow end 410 and a wide end 420. A wedge 400 is inserted between each adjacent pair of spokes 225 after winding is completed. The narrow end 410 of the wedge 400 is first inserted, or threaded, between the spokes 225, and then the wide end 420 is forced between the spokes 225 by pulling on the narrow end 410. At that point, the wide end 420 will fill the slot 245, and assume a wedge shape. Once all wedges 400 are in place, the wire 250 is varnished to the stack 330, and the varnish is allowed to cure. Finally, the wedges 400 are removed.

The resulting ratio of wire 250 area to slot 245 area in cross-section through the winding core 340 is optimized for lowest resistance-induced energy loss to heat, at peak power output. Returning to FIG. 2, we see how the thickness of a single layer wire 250 compares with the area of the slots 245 between the spokes 225. The percentage of area between RH and RO that is open to axial air flow should, after winding, still exceed 20%, and preferably exceed 30%.

A person of ordinary skill in the art will recognize that alternative geometries are possible that can also achieve such a high ratio of space to solid material area in the axial direction through the winding core 340. For example, the spokes 225 may be different from those of the winding core 340 shown in FIGS. 2 and 3 in shape and/or in number. There might be additional cross-sectional material, oriented in other directions, such as concentrically. However, any motor is regarded as being within the scope of the invention described herein that achieves axial space to solid material ratios consistent with those specified above.

In addition to increasing the space for air flow through the armature 155, the above-described winding/wedging/varnishing process achieves close contact between the wire 250 and the laminations 200. Thus, the entire winding core 340 becomes a sink for heat produced when electricity flows through the wire. This effect of increasing the heat capacity of the winding core 340 also contributes to preventing thermal runaway.

A small counterbore 320 in the armature assembly 155 seats bushing 195 and bearing 185 (see FIG. 1), which support the power delivery shaft 115. The bushing 195 ensures stable alignment of the rotor assembly 105 around the stator assembly 150. A second bearing 190, distal from the rotor cylinder 110, further supports the shaft 115 for rotational movement of the shaft 115 with respect to the mounting end bell 165. The mounting end bell 165 is insert-molded with bearings 185 and 180 in place. The bearings are typically fabricated from steel, although other materials can be used. As described above with respect to the rotor end bell 120, the mounting end bell 165 may be molded of any suitable plastic, such as RYTON PPS.

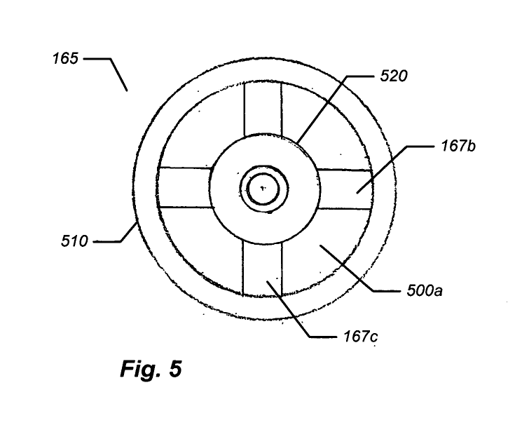

FIG. 5 depicts the mounting end bell 165 of the armature assembly 155. In this view looking in the positive Z-direction, the narrowness of the struts 167, typified by struts 167b and 167c, can be appreciated. In the embodiment shown in the figure, the struts 167 are in scale proportionately to the rest of the mounting end bell 165. A side view of the mounting end bell 165 and struts 167 is provided by FIG. 1. Clearly, the struts 167, typified in FIG. 1 by strut 167a are skeletal, allowing air to freely ventilate the armature assembly 155. When the rotor assembly 105 is spinning, the openings 168 formed by elongation of the struts 167 in the Z-direction, as seen in FIG. 1, cause air to be pulled through the stator slots 245 somewhat like a centrifugal blower.

FIG. 5 illustrates the projection of the struts 167 of the mounting end bell 165 onto a plane that is oriented perpendicular to the shaft 115 axis. The axial spaces 500, typified by space 500a between adjacent struts 167b and 167c further facilitate air flow past the windings 300 of the armature assembly 155. The outer circle 510 of the mounting end bell 165 aligns with the outside of the rotor cylinder 110.

Just as the winding core 340 cross-section can vary in geometry without departing from the inventive concept, so can the detailed geometry of the mounting end bell 165. Essentially, the mounting end bell 165 should be rigid and substantially permeable to air flowing at least axially. The axial ratio of space to solid material in the mounting end bell 165 should be at least 25%, and preferably should be greater than 30%. Like the armature 155, the mounting end bell 165 has a central hub 520, bounded by a circle. In a projection of the type shown in the figure, the projected (i.e., axial) ratio of space to solid material in the mounting end bell 165 outside the central hub 520 should be at least 30% and preferably should be greater than 40%. Because of their curving skeletal shape, the struts 167 of the mounting end bell 165 shown in FIGS. 1 and 5 offer the advantage of allowing radial, as well as axial, air movement. The radial air flow can either entrain air into axial flow in the negative Z-direction, or evacuate air moving axially in the positive Z-direction, in either case contributing to flow of air through the armature 155.

The mounting end bell 165 might have struts 167 having shapes different from those shown in FIGS. 1 and 5. It might have concentric spaces, some combination of concentric and radial structures, or any other structure achieving the above ratios, all within the scope of the invention so long as the space to solid matter ratios permit substantial air flow into and out from the winding core 340.

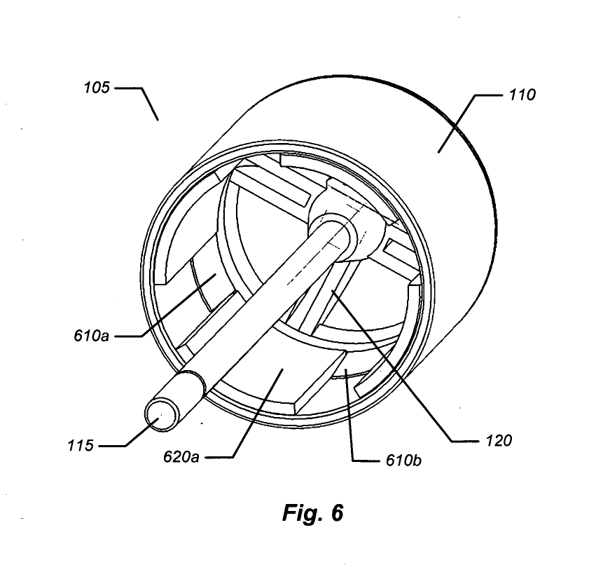

FIG. 6 shows the rotor assembly 105 in isolation. The rotor end bell 120, as previously described, engages a steel rotor cylinder 110 and a steel shaft 115. The insert-molding process allows close control over the dimensions of the rotor assembly 105. The molding process produces magnet alignment features 610, or spacing fingers, typified by 610a and 610b, around the interior of the rotor cylinder 110. Strong rare-earth magnets 620, typified by magnet 620a, are spaced between the features 610. During assembly, the magnets 620 exert attracting/repelling force on each other, tending to inhibit their precise alignment. The alignment features 610 ensure that magnets 620 are properly seated. The features 610 also serve to keep the magnets 620 from drifting in position when the motor 100 is operating, particularly when the structure upon which the motor 100 is mounted undergoes significant acceleration.

FIG. 1 shows the rotor assembly 105 viewed from the side. The shaft 115, rotor cylinder 110, and rotor end bell 120 are visible. A plurality of radial blades 127, typified by blade 127a, provide a framework for the rotor end bell 120. FIG. 7 shows the rotor assembly 105 looking in the positive Z-direction. The relative narrowness of the blades 127 is clearly apparent from the large portion of the winding core 340 that is visible through openings 700, typified by opening 700a, between adjacent blades 127b and blade 127c. This configuration leaves the rotor end bell 120 largely open to flow of air parallel to the shaft 115.

In the embodiment shown, when viewed from the side as in FIG. 1, the blades 127 are wedge-shaped, each describing a solid in a portion of plane parallel to the shaft 115. Four blades 127 are included in the embodiment shown in FIG. 7, spaced at intervals in θ of 90 degrees. Although the number and shape of these blades 127 may vary within the scope of the invention, the particular blade-like shape in the embodiment shown in the figure has the advantage of augmenting air flow through the interior of the winding core 340.

Again, other geometries of the blades 127 are possible within the scope of the invention. The blades 127 may differ in shape and/or number, or have some other geometry entirely. For example, while each blade 127 shown in FIG. 1 and FIG. 7 is essentially flat in a plane parallel to the axis of the shaft 115 (i.e., an R-θ plane), another embodiment might use blades that are contoured into a shape like a house fan blade or boat propeller. In such cases, the blades might be flat, or might be curved and thin, with an essentially uniform thickness over some portion of the blade. On the other hand, the blades might be fashioned to more closely resemble skeletal struts 167, like those used in the mounting end bell 165. In any case, the blades 127 should provide structural integrity and should be largely permeable to axial air flow and, optionally, radial flow. In the axial direction, the rotor end bell 120 should have a ratio of space to solid material of at least 40%, and preferably greater than 50%.

The motor 100 may be mounted in or on a superstructure, such as a model airplane or helicopter, such that air will impinge upon the motor as a result of the motion of the superstructure. In such situations, the permeability of the motor 100 to relative air velocity parallel to the axis not only will cool the components of the motor 100, but also may reduce resistance of the superstructure to forward motion. The motor 100 might drive a ducted fan or a propeller.

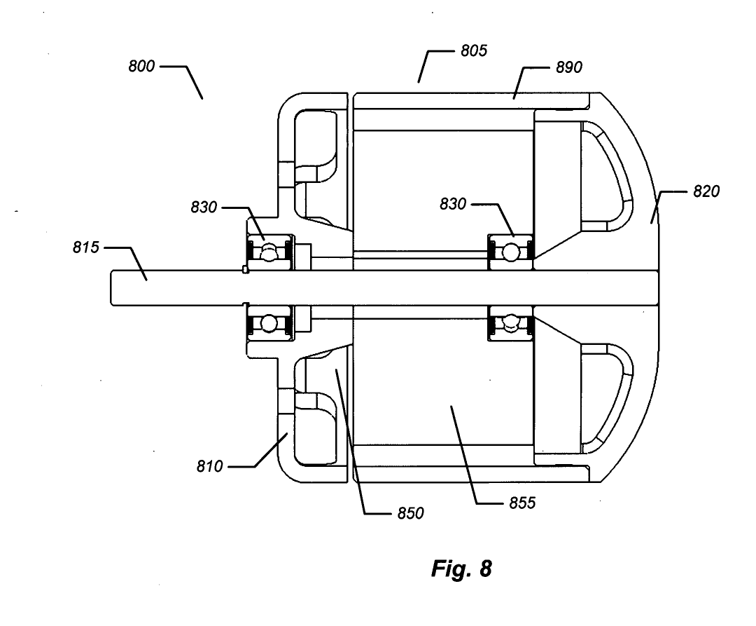

FIG. 8 shows a motor 800 with an alternate stator end bell 810 construction. In this alternative embodiment, the stator end bell 810 is shorter and more compact than the version of FIG. 1. It supports shaft 815 via bearings 830 and has no intermediate bushing. Further, rotor end bell 820 has a lower profile than the rotor end bell 120 of FIG. 1. In other respects, the motor 800 is analogous to that of FIG. 1-7, with a stator assembly 850 disposed generally inside a rotor assembly 805. The stator assembly 850 includes an armature assembly 855 having steel laminations in the form of spokes, each spoke wound in wire forming a winding core. The rotor assembly 805 further includes a rotor end bell 820 attached to a rotor cylinder 890.

In some embodiments, a motor 100 may be constructed, using structures and methods described herein, that weighs at least 120 grams and can produce an average of at least 1600 watts of power over an interval of at least 150 seconds, with the temperature of the wire 250 not exceeding 140 Celsius.

Of course, many variations of the above method are possible within the scope of the invention. For example, the respective structures of the mounting end bell and the rotor end bell can vary considerably while still allowing substantial axial air flow consistent with the inventive concept. The present invention is, therefore, not limited to all the above details, as modifications and variations may be made without departing from the intent or scope of the invention. Consequently, the invention should be limited only by the following claims and equivalent constructions.

What is claimed is:

1. An electric motor, comprising:
a) a stator assembly, including:
(i) an armature assembly of magnetic material, said armature assembly having a plurality of spokes extending radially from a central hub, with each spoke being wound with a single layer of conducting wire; and
(ii) a mounting end block, capping a rotor assembly toward the load end of the shaft, the mounting end block containing a plurality of radially oriented struts that provide structural support to the mounting end block, and that describe spaces which permit axial flow of air into and out from the armature assembly.
b) the rotor assembly mounted to, and configured for rotational movement relative to, the stator assembly, the rotor assembly including
(i) a shaft passing through the central hub, the shaft having an axis, a load end, and a distal end.
(ii) a rotor cylinder, surrounding the armature assembly; and
(iii) a rotor end bell, attached to the distal end of the shaft and capping an end of the rotor cylinder, the rotor end bell describing slots that allow air to flow axially to and from the armature assembly through the rotor end bell.

2. The motor of claim 1, the rotor assembly further including:
(iv) a plurality of magnets, mounted on the inside of the rotor cylinder.

3. The motor of claim 2, wherein the exterior of the rotor cylinder is magnetically permeable, the magnets are rare earth magnets, and pairs of the magnets are separated by registers.

4. The motor of claim 1, wherein the ratio, in a direction parallel to the axis, of area of the slots to solid material through the rotor end bell is at least 40%.

5. The motor of claim 4, wherein the ratio is at least 50%.

6. The motor of claim 1, wherein the rotor end bell contains a plurality of blades that contribute to structural rigidity of the rotor end bell, the geometry of the blades affecting the respective shapes of the slots.

7. The motor of claim 1, wherein each blade has an essentially flat planar surface.

8. The motor of claim 1, wherein each blade is a curved fan blade.

9. The motor of claim 1, the struts being elongated in a direction parallel to the axis, thereby allowing radial flow of air into and out from the stator assembly.

10. The motor of claim 1, wherein the mounting end block describes spaces, such that the ratio, in a direction parallel to the axis, of area of the spaces to solid material through the rotor end bell is at least 30%.

11. The motor of claim 10, wherein the ratio is at least 40%.

12. The motor of claim 1, wherein
(i) the central hub is circular of radius RH,
(ii) the spokes have outer edges that lie on a circle of radius RR, and
(iii) RH is no greater than 60% of RR.

13. The motor of claim 1, wherein RH is no greater than 50% of RR.

14. The motor of claim 1, wherein, in a cross-section perpendicular to the axis, through the armature assembly before the spokes are wrapped with wire, the ratio of empty space to solid material is at least 50%.

15. The motor of claim 1, wherein, in a cross-section perpendicular to the axis, through the armature assembly after the spokes are wrapped with wire, the ratio of empty space to solid material is at least 20%.

16. The motor of claim 15, wherein the ratio at least 30%.

17. The motor of claim 1, wherein the ratio of solid material to open area in the axial direction is at least 20% through each of the armature assembly, the mounting end bell, and the rotor end bell.

18. The motor of claim 17, the mounting end bell coupling the shaft to the propeller of a model airplane or model helicopter, or to a ducted fan.

19. The motor of claim 1, wherein the motor weighs at least 120 grams and is capable of producing an average of at least 1600 watts of power over an interval of at least 150 seconds, while the wire has a maximum temperature that does not exceed 140 degrees Celsius.

20. The motor of claim 19, wherein the rotor end bell is fabricated from thermoplastic.

21. The motor of claim 19, wherein the mounting end bell is fabricated from thermoplastic.

22. The motor of claim 1, the conducting wire having been attached to the spokes by a process including the following steps:
(A) winding conducting wire, under tension, in a single layer around an core of magnetic material, said core having a plurality of spokes extending radially from a central hub;
(B) after the winding step, inserting wedges into slots between the spokes, thereby bringing the wire into substantial contact with the core;
(C) applying varnish to exposed portions of the wire;
(D) curing the varnish; and
(E) removing the wedges.

23. The motor of claim 1, the rotor end bell being molded to the rotor cylinder.

24. A method, comprising
a) winding conducting wire, under tension, in a single layer around an core of magnetic material, said core having a plurality of spokes extending radially from a central hub;
b) after the winding step, inserting wedges into slots between the spokes, thereby bringing the wire into substantial contact with the core;
c) applying varnish to exposed portions of the wire;
d) curing the varnish; and
e) removing the wedges.

25. A motor, comprising:
a) a stator assembly, including:
(i) an armature assembly of magnetic material, said armature assembly, including
(A) a plurality of spokes extending radially from a central hub, and
(B) conducting wire, wrapping each spoke and connected to a power source, and
(ii) a mounting end bell being configured for coupling a shaft to an external load;
b) a rotor assembly mounted to the stator assembly, and configured for rotational movement with respect to the stator assembly, the rotor assembly including
(i) the shaft, passing through the central hub, and having an axis, a load end, and a distal end, the shaft being rotated by electromagnetism when the motor is powered by the power source,
(ii) a rotor cylinder, including a plurality of magnets distributed around its interior surface, the axis of the rotor cylinder being parallel to the shaft axis, the rotor cylinder surrounding the armature assembly, and
(ii) a rotor end bell located at the distal end of the shaft axis, opposite to the mounting end bell;

26. A method, comprising operating a brushless electric motor, which includes a winding core and has a weight of at least 120 grams, over an interval of at least 150 seconds while:
a) producing with the motor an average of at least 1600 watts of power;
b) allowing air to flow over the winding coil; and
c) maintaining a temperature of wire in the winding core not exceeding 140 Celsius.
